(19) United States
(12) Patent Application Publication
(10) Pub. No.: US 2004/0019914 A1
(43) Pub. Date: Jan. 29, 2004

(54) Systems and methods for routing signals in an entertainment system

(76) Inventors: Walter Easterbrook, Hancock, NY (US); John E. Harrity, Centreville, VA (US)

Correspondence Address: John E. Harrity, Suite 300, 11240 Waples Mill Road, Fairfax, VA, 22030, US

(21) Appl. No.: 10/241,698

(22) Filed: Sep. 12, 2002

Related U.S. Application Data
(60) Provisional application No. 60/397,603, filed on Jul. 23, 2002.

(51) Int. Cl. H04N 7/173; H04N 7/16

(52) U.S. Cl. 725/141; 725/151; 725/131

(57) ABSTRACT

A connector unit interconnects a group of components in an entertainment system. The connector unit connects to a television and the group of components. The connector unit allows for selection of one of the group of components and routes signals from the selected component to the television.

### RELATED APPLICATION

This application claims priority under 35 U.S.C. § 119 based on U.S. Provisional Application No. 60/397,603, filed Jul. 23, 2002, the disclosure of which is incorporated herein by reference.

### FIELD OF THE INVENTION

The present invention relates generally entertainment systems and, more particularly, to systems and methods for routing signals between components in an entertainment system.

### BACKGROUND OF THE INVENTION

Interconnecting components in an entertainment system has always been a difficult endeavor for even the most learned individual. This is especially true when individuals seek to interconnect a large number of components. For example, it is quite common for individuals to desire to connect cable or satellite receivers, video cassette recorders (VCRs), digital video disk (DVD) players, camcorders, video game consoles, surround sound systems, computers, and the like to a television set. People often struggle, however, determining what type(s) of cables to use (e.g., coaxial cables, S video cables, 3 RCA cables, etc.) to interconnect all of these components and where on these different components to connect the cables. As a result, people often require assistance from an experienced individual to properly connect the entertainment components.

In some instances, the components in a person's entertainment system may only accept specific types of cables. For example, an older television set may only include a connector for receiving a coaxial cable. Newer components, such as DVD players, video game consoles, and the like, however, may only include connectors for receiving an S video cable and/or a 3 RCA cable. To properly connect the newer components to the older television set, the individual would be required to purchase specialized splitters and adapters for routing signals been the non-analogous connectors. Again, people often require the assistance of an experienced individual to make these types of interconnections.

Therefore, there exists a need for systems and methods that facilitate the interconnection of components in an entertainment system.

### SUMMARY OF THE INVENTION

Systems and methods consistent with the present invention address this and other needs by providing a mechanism that allows for components in an entertainment system to be easily interconnected.

In accordance with the purpose of this invention as embodied and broadly described herein, a method for interconnecting a group of components in an entertainment system is disclosed. The method includes connecting a television to a connector unit, connecting the group of components to the connector unit, selecting one of the group of components, and routing signals from the selected component to the television via the connector unit.

In another implementation consistent with the present invention, a system for routing signals in an entertainment system is disclosed. The system includes one or more television connectors, one or more cable/satellite receiver connectors, one or more video cassette recorder connectors, one or more digital video disk connectors, a selector device, and a converter unit. The television connectors are configured to receive one or more connector cables from a television. The cable/satellite receiver connectors are configured to receive one or more connector cables from one of a cable receiver and satellite receiver. The video cassette recorder connectors are configured to receive one or more connector cables from one or more video cassette recorders. The digital video disk connectors are configured to receive one or more connector cables from a digital video disk device. The selector device is configured to receive a selection of one of the cable or satellite receiver, the one or more VCRs, and the DVD device from a user. The converter unit is configured to format signals for transmission between the television and the selected one of the cable or satellite receiver, the one or more VCRs, and the DVD device.

In yet another implementation consistent with the present invention, a method for connecting components in an entertainment system is provided. The method includes connecting a cable from a television to a connector unit, connecting a power cord from the television to the connector unit, connecting at least one cable from each of the group of components to the connector unit, connecting a power cord from each of the group of components to the connector unit, and routing signals between the group of components and the television via the connector unit.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system in which systems and methods, consistent with the present invention, may be implemented;

FIG. 2 illustrates an exemplary configuration of the connector unit of FIG. 1 in an implementation consistent with the present invention;

FIG. 3 illustrates an exemplary alternative configuration of the connector unit of FIG. 1 in an implementation consistent with the present invention;

FIG. 4 illustrates another exemplary configuration of the connector unit of FIG. 1 in an implementation consistent with the present invention;

FIG. 5 illustrates an exemplary menu that may be displayed to a user in an implementation consistent with the present invention;

FIG. 6 illustrates an exemplary functional block diagram of the connector unit of FIG. 1;

FIG. 7 illustrates an exemplary alternative functional block diagram of the connector unit of FIG. 1;

FIG. 8 illustrates an exemplary process for routing signals to a television in an implementation consistent with the present invention;

FIG. 9 illustrates an alternative exemplary configuration of the connector unit of FIG. 1 in an implementation consistent with the present invention;

FIG. 10 illustrates an exemplary functional block diagram of the connector unit of FIG. 9;

FIG. 11 illustrates an exemplary alternative functional block diagram of the connector unit of FIG. 9; and

FIG. 12 illustrates an exemplary process for connecting electrical components to a television in an implementation consistent with the present invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and their equivalents.

Implementations consistent with the present invention provide a connector device for interconnecting components of an entertainment system. The connector device includes a group of connectors that are separated by the component to which the connectors should be connected. For example, the connectors for connecting to a television are separated from the connectors for a cable/satellite receiver, DVD player/recorder, VCR, and other common peripheral components. The connector device formats signals transmitted between the components of the entertainment system based on the particular cables with which the components are connected to the connector device thereby allowing the components of the entertainment system to be easily interconnected. The connector device also allows for the selection of the component(s) from which signals are to be routed. As a result, routing priority may be easily set by the user.

### Exemplary System

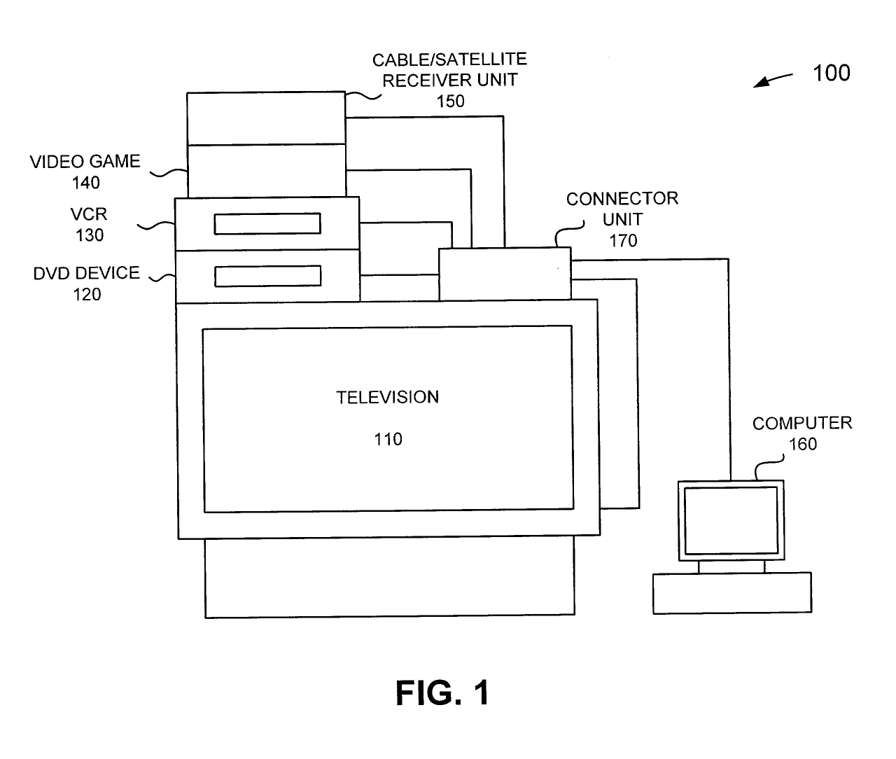

FIG. 1 illustrates an exemplary system 100 in which systems and methods, consistent with the present invention, may be implemented. System 100 includes a television 110, a DVD device 120, a VCR 130, a video game device 140, a cable/satellite receiver unit 150, a computer 160, and a connector unit 170. The number of components illustrated in FIG. 1 has been shown for simplicity. It will be appreciated that a typical system may include more or fewer components than illustrated in FIG. 1. Moreover, it will be appreciated that system 100 may include other devices that may connect to a television, such as a surround sound system, a camcorder, or the like, not illustrated in FIG. 1.

Television 110 may include any type of conventional television capable of presenting video and/or audio signals to a user. Alternatively, television 110 may include one or more display devices, such as a computer display, capable of displaying video to a user. Television 110 may include one or more connectors for transmitting and/or receiving video and/or audio signals. For example, television 110 may include a coaxial cable connector, an S video cable connector, and/or a 3 RCA cable connector that allows the television to transmit/receive video and/or audio signals via a coaxial cable, S video cable, and 3 RCA cable, respectively.

DVD device 120 may include one or more conventional DVD players capable of playing DVDs or compact disks. DVD device 120 may also include a DVD recorder capable of recording video and audio to a compact disk. DVD device 120 may include one or more connectors for transmitting/receiving video and audio signals. For example, DVD device 120 may include an S video cable connector and/or a 3 RCA cable connector.

VCR 130 may include any conventional VCR device capable of playing and/or recording video and audio signals. VCR 130 may include one or more connectors for transmitting/receiving video and audio signals. For example, VCR 130 may include a coaxial cable connector, an S video cable connector, and/or a 3 RCA cable connector.

Video game device 140 may include any conventional video game device, such as those produced by Sony™ and Nintendo™. Video game device 140 may include one or more connectors for transmitting video and audio signals. For example, video game device 140 may include a coaxial cable connector and/or a 3 RCA cable connector.

Cable/satellite receiver unit 150 may include any conventional cable and/or satellite receiver unit. Cable/satellite receiver unit 150 may include one or more connectors for transmitting video and audio signals. For example, cable/satellite receiver unit 150 may include a coaxial cable connector, S video cable connector, and/or a 3 RCA cable connector.

Computer 160 may include a desktop computer, laptop, or any other type of computer device. Computer 160 may include one or more connectors for transmitting and/or receiving video and audio signals. For example, computer 160 may include a S video connector.

Connector unit 170 facilitates the interconnection of the components 110-160 of system 100. Connector unit 170 may include a group of connectors capable of interconnecting television 110, DVD device 120, VCR 130, video game unit 140, cable/satellite receiver unit 150, and computer 160. As will be described in detail below, connector unit 170 separates the connectors for the different components 110-160 of system 100 so as to aid a user in connecting the components 110-160. Connector unit 170 may also include a group of converters for converting signals between different formats. For example, connector 170 may convert signals transported over a coaxial cable to the appropriate format for transport over S video cables, 3 RCA cables, or other types of cables.

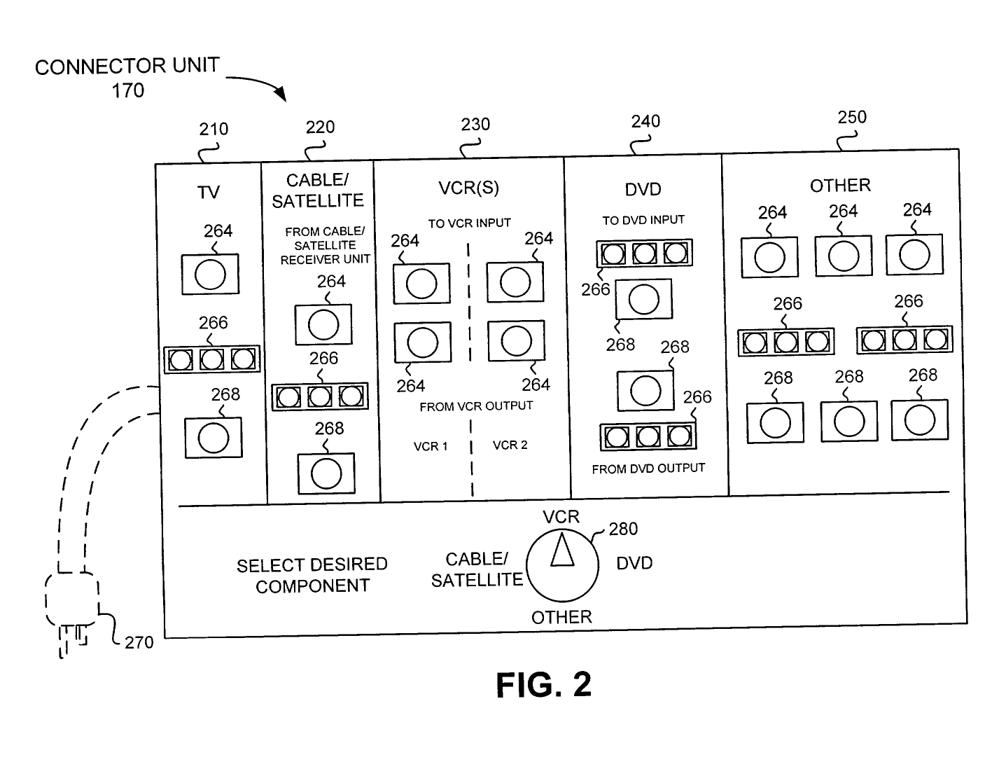

FIG. 2 illustrates an exemplary configuration of connector unit 170 of FIG. 1 in an implementation consistent with the present invention. As illustrated, connector unit 170 may include a set of television connectors 210, a set of cable/satellite connectors 220, a set of VCR connectors 230, a set of DVD connectors 240, other sets of connectors 250, an optional power cord 270, and a selector knob 280. Power cord 270 allows connector 170 to be connected to a power supply. Alternatively, connector 170 may include a battery power supply (or some other type of power supply) or may not include any power supply in some implementations consistent with the present invention. In such situations, connector 170 may not include power cord 270.

Television connector set 210 may include one or more connectors for interconnecting television 110 to connector unit 170. The connectors may include, for example, a coaxial cable connector 264, a 3 RCA cable connector 266, and an S video cable connector 268. Coaxial cable connector 264 is capable of receiving a coaxial cable. 3 RCA cable connector 266 is capable of receiving a 3 RCA cable. S video cable connector 268 is capable of receiving an S video cable.

Cable/satellite connector set 220 may include one or more connectors for interconnecting cable/satellite receiver unit 150 to connector unit 170. The connectors may include, for example, a coaxial cable connector 264, a 3 RCA cable connector 266, and an S video cable connector 268. VCR connector set 230 may include connectors for interconnecting one or more VCRs 130 to connector unit 170. The connectors may include, for example, coaxial cable connectors 264, 3 RCA cable connectors (not shown), and S video cable connectors (not shown). Coaxial cable connectors 264 may include connectors via which video and audio signals are transmitted to VCR 130 and connectors via which video and audio signals are received from VCR 130. Connector unit 170 may facilitate the connection of the appropriate coaxial cables to the appropriate coaxial cable connectors 264 by indicating on connector unit 170 where the cables are to be connected. For example, connector unit 170 may include labeling, such as “TO VCR INPUT” and “FROM VCR OUTPUT,” to aid a user in interconnecting connector unit 170 and VCR 130. In an alternative implementation, VCR connector set 230 (and the other sections 210, 220, 240, and 250) of connector unit 170 may include color coding to facilitate the connection of cables to the appropriate location on connector unit 170.

DVD connector set 240 may include one or more connectors for interconnecting DVD device 120 to connector unit 170. The connectors may include, for example, 3 RCA cable connectors 266 and S video cable connectors 268. When DVD device 120 includes recording capabilities, connector unit 170 may include separate connectors for receiving video and audio signals from DVD device 120 and separate connectors for transmitting video and audio signals to DVD device 120. In such a situation, connector unit 170 may include labeling, such as “TO DVD INPUT” and “FROM DVD OUTPUT,” to aid a user in interconnecting DVD device 120 and connector unit 170. Alternatively, a single connector may transport video and audio signals between DVD device 120 and connector unit 170.

Other connector set 250 may include one or more connectors for interconnecting other entertainment components, such as a video game unit 140, a computer 160, a camcorder, a surround sound system, and the like, to connector unit 170. The connectors may include, for example, one or more coaxial cable connectors 264, one or more 3 RCA cable connectors 266, one or more S video cable connectors 268, or other types of connectors.

It will be appreciated that by labeling the different sections of connector unit 170 in the manner illustrated in FIG. 2 facilitates the connection of cables to connector unit 170. For example, a user could readily determine that a coaxial cable from a television, such as television 110, should be connected to the appropriate connector in television connector set 210. Alternatively, color coding may be used to facilitate the connection of cables to connector unit 170.

Selector knob 280 allows a user to select the device from which signals are to be routed to television 110. By rotating selector knob 280, the user may choose to have signals routed to television 110 from the connectors in cable/satellite connector set 220, VCR connector set 230, DVD connector set 240, or other connector set 250.

The number and types of connectors in each connector set 210-250 have been provided for simplicity. It will be appreciated that connector unit 170 may include more or fewer connectors or other types of connectors than illustrated in FIG. 2.

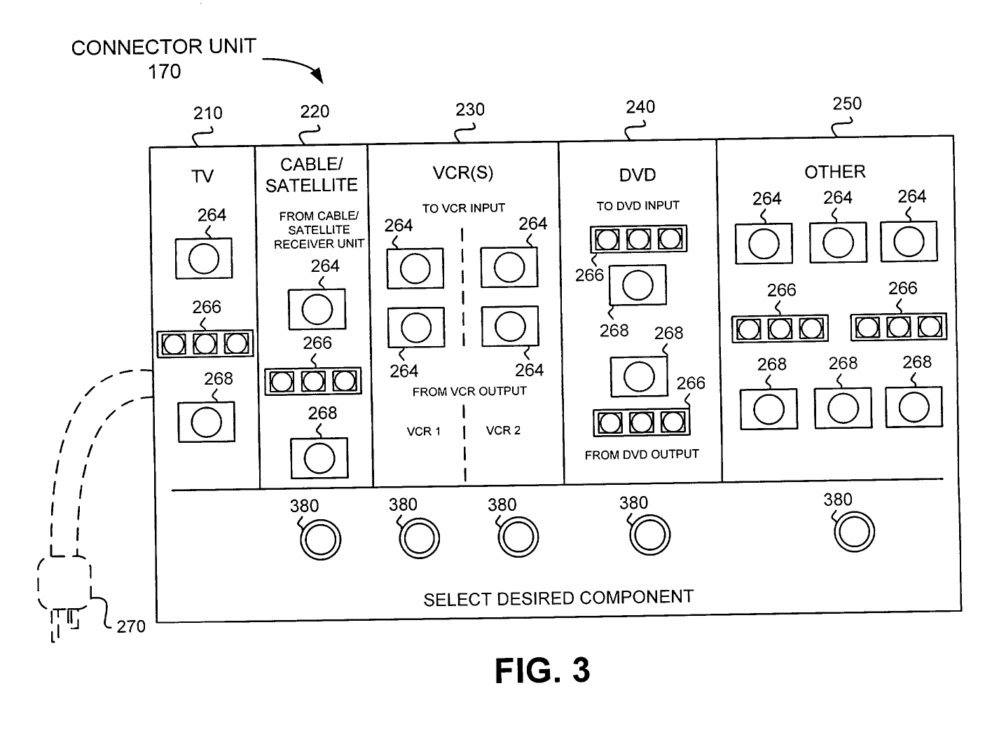

FIG. 3 illustrates an alternative configuration of connector unit 170 of FIG. 1 in an implementation consistent with the present invention. The connector unit of FIG. 3 is configured in a similar manner to the connector unit of FIG. 2 except that the selector knob 280 is replaced with selector buttons 380. By depressing the appropriate selector button 380, a user may select the component from which signals are to be routed to television 110.

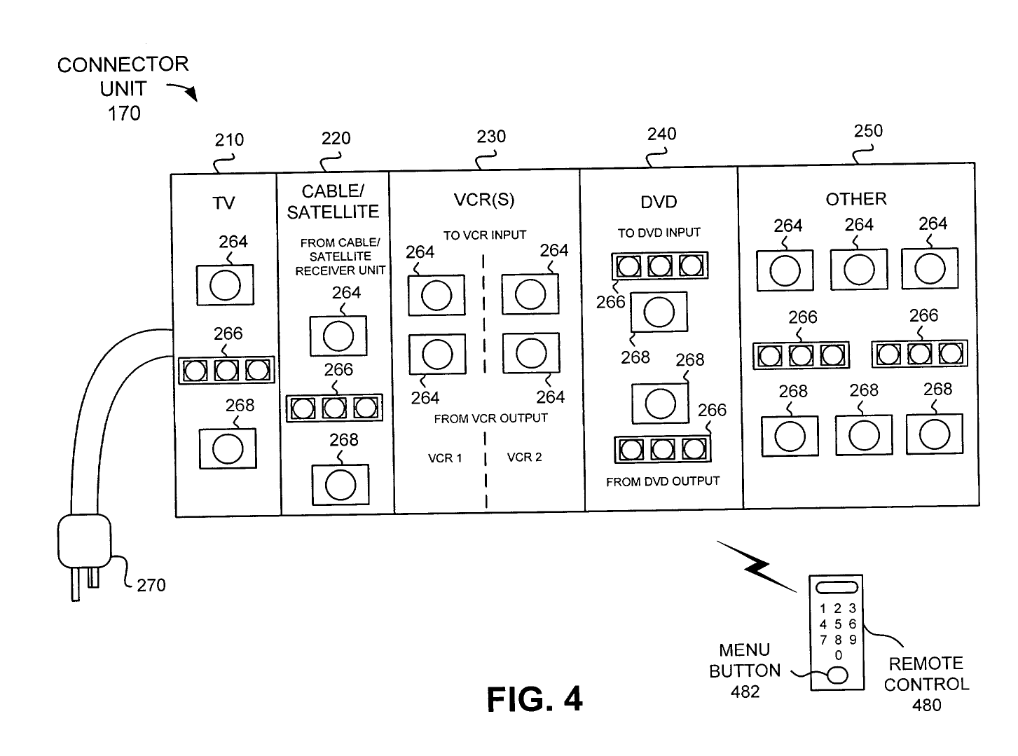

FIG. 4 illustrates another configuration of connector unit 170 of FIG. 1 in an implementation consistent with the present invention. The connector unit of FIG. 4 is configured in a similar manner to the connector unit of FIG. 2 except that the selector knob 280 is replaced with remote control 480. In such a situation, connector unit 170 may include one or more conventional devices for receiving signals from remote control 480. Remote control 480 may include a menu button 482 that causes a menu to be displayed on television 110.

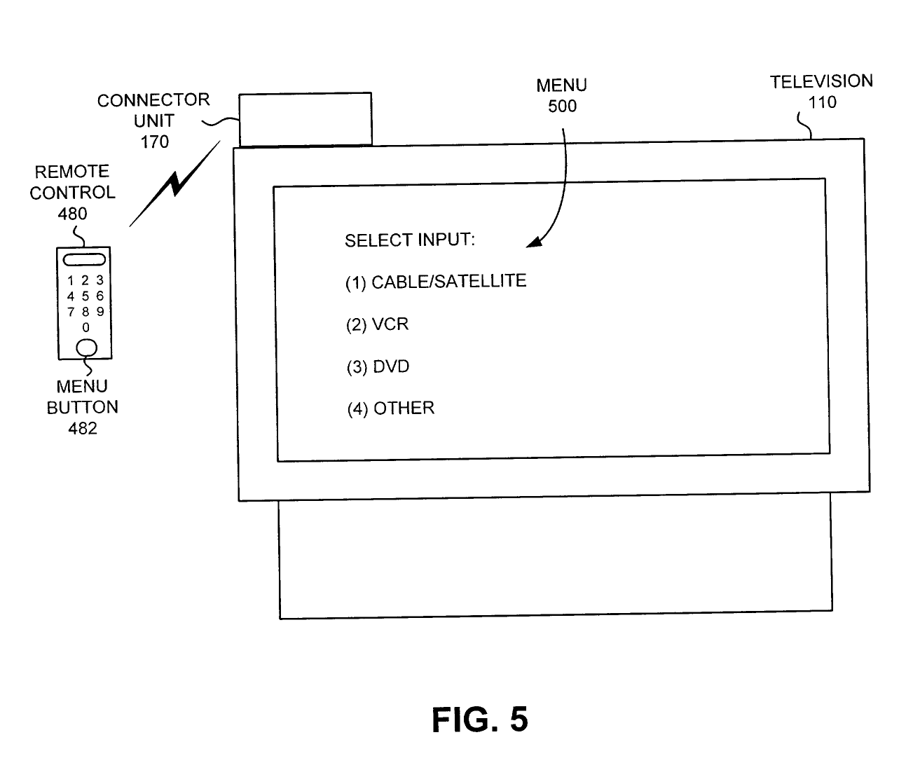

FIG. 5 illustrates an exemplary menu 500 that may be displayed to a user in an implementation consistent with the present invention. By depressing menu button 482 on remote control 480, menu 500 may be displayed on television 110. As illustrated, menu 500 may allow the user to choose to have signals routed to television 10 from cable/satellite receiver 150, VCR 130, DVD 120, or the other components connected to connector unit 170. For example, by selecting “1” on remote control 480, the user may select to have signals routed to television 110 from cable/satellite receiver 150.

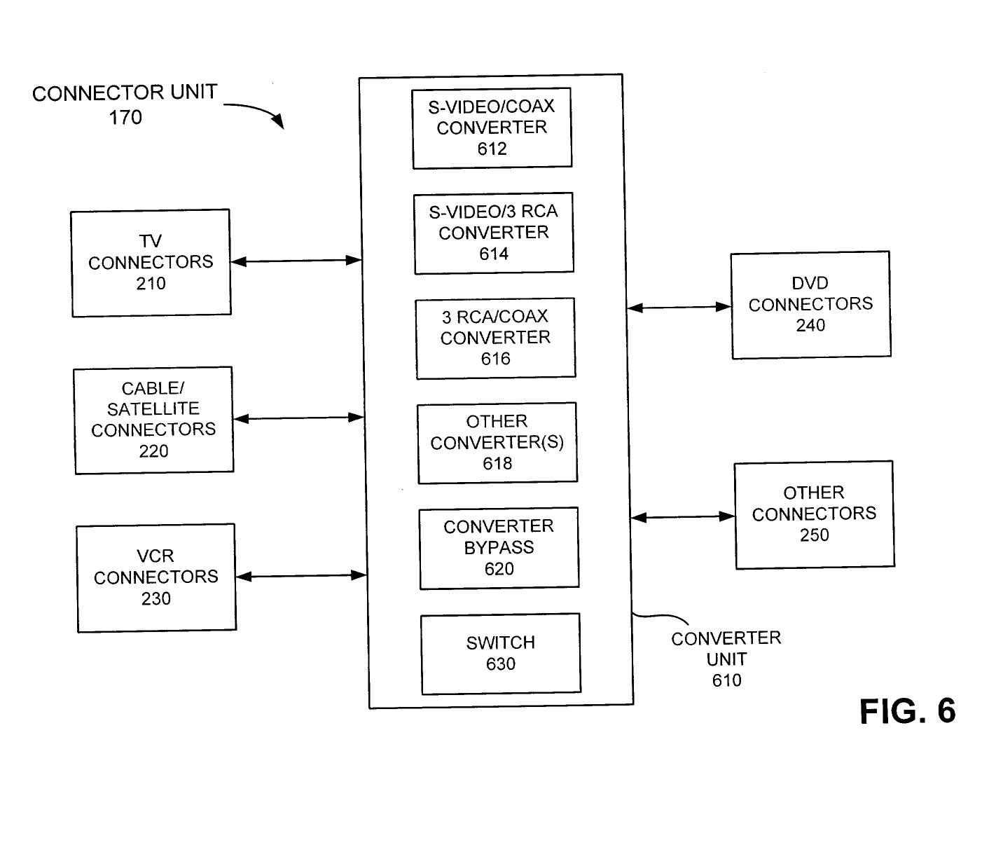

FIG. 6 illustrates an exemplary functional block diagram of connector unit 170 of FIG. 1. As illustrated, connector unit 170 may include television (TV) connectors 210, cable/satellite connectors 220, VCR connectors 230, DVD connectors 240, other connectors 250, and a converter unit 610. As set forth above, TV connectors 210, cable/satellite connectors 220, VCR connectors 230, DVD connectors 240, and other connectors 250 may include coaxial cable connectors, 3 RCA cable connectors, S video cable connectors, and/or other conventional types of connectors.

Converter unit 610 may include an S video/coax converter 612, an S video/3 RCA converter 614, a 3 RCA/coax converter 616, other converters 618, a converter bypass unit 620, and a switch 630. S video/coax converter 612 formats signals transmitted over an S video cable for transmission over a coaxial cable, and vice versa, using well-known techniques. S video/3 RCA converter 614 formats signals transmitted over an S video cable for transmission over a 3 RCA cable, and vice versa, using well-known techniques. 3 RCA/coax converter 616 formats signals transmitted over a 3 RCA cable for transmission over a coaxial cable, and vice versa, using well-known techniques. Other converters 618 may include one or more converters that format signals for transmission between other types of conventional cables.

Converter bypass unit 620 transports signals between similar connectors. For example, converter bypass unit 620 may transport signals between a coaxial connector of VCR connectors 230 and a coaxial connector of TV connectors 210. Switch 630 may include one or more conventional switches that act to route signals from a selected component of system 100 to TV connectors 210. As set forth above, the desired component may be selected using selector knob 280, selector buttons 380, or remote control 480.

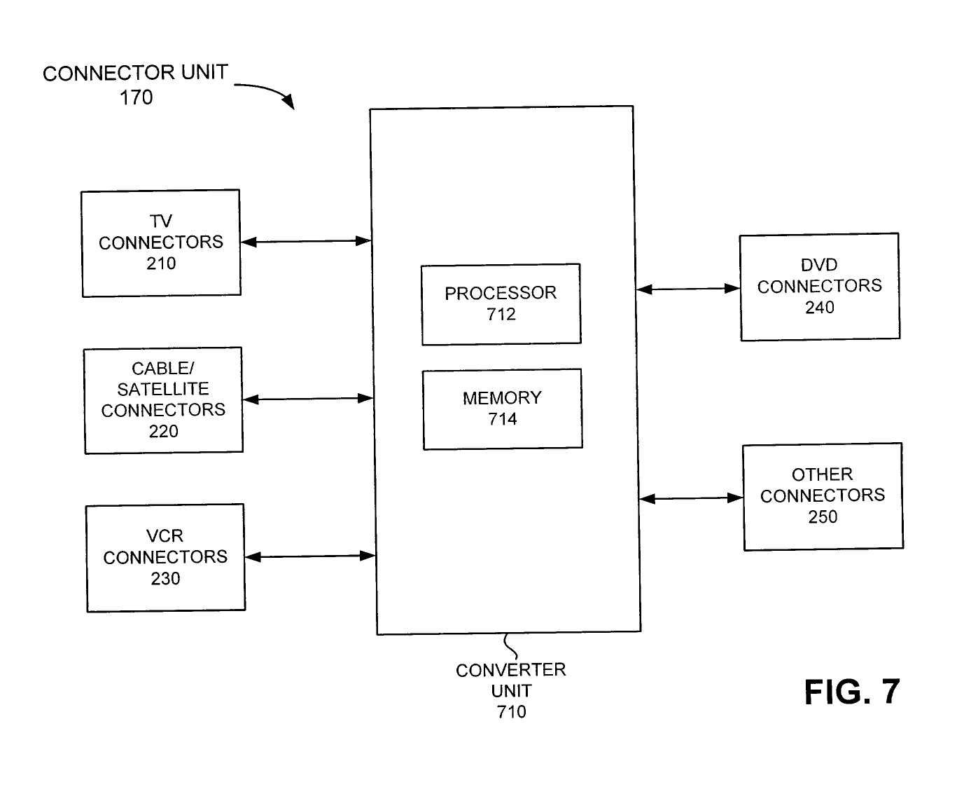

FIG. 7 illustrates an alternative exemplary functional block diagram of connector unit 170 of FIG. 1. As illustrated, connector unit 170 may include TV connectors 210, cable/satellite connectors 220, VCR connectors 230, DVD connectors 240, other connectors 250, and a converter unit 710. As set forth above, TV connectors 210, cable/satellite connectors 220, VCR connectors 230, DVD connectors 240, and other connectors 250 may include coaxial cable connectors, 3 RCA cable connectors, S video cable connectors, and/or other conventional types of connectors.

In this implementation, converter unit 710 may include a processor 712 and a memory 714. Processor 712 may include any type of conventional processor or microprocessor that interprets and executes instructions. Memory 714 may include a random access memory (RAM) or another type of dynamic storage device that stores information and instructions for execution by processor 712 and/or a read only memory (ROM) or another type of static storage device that stores static information and instructions for use by processor 712.

Processor 712 performs the functions described above with respect to converters 612-618, converter bypass unit 620, and switch 630. That is, processor 712 receives signals from a connector associated with a selected component of system 100, formats the signals (if necessary), and forwards the signals to the appropriate destination connector. For example, assume a user wishes to transmit signals from DVD device 120 to television 110. Assume further that DVD device 120 connects to connector unit 170 via an S video cable and that television 110 connects to connector unit 170 via a coaxial cable. In such a situation, the user may select the DVD device via selector knob 280, the appropriate selector button 380, or remote control 480. Processor 412 may then receive signals from an S-video connector 268 of DVD connector set 240, format the signals for transmission via a coaxial cable, and forward the signals to a coaxial connector 264 of television connector set 210.

### Exemplary Processing

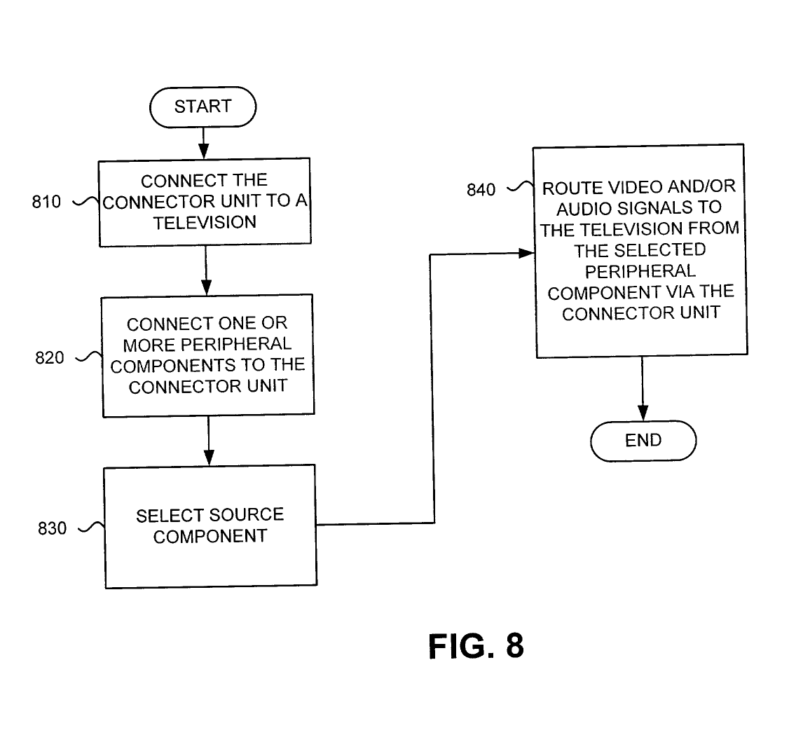

FIG. 8 illustrates an exemplary process for routing signals to a television in an implementation consistent with the present invention. Processing may begin by connecting a television, such as television 110, to connector unit 170 [act 810]. As described above, television 110 may, for example, connect to an appropriate connector of television connector set 210 of connector unit 170 via a coaxial cable, 3 RCA cable, an S video cable, or some other similar type of cable. Other peripheral components may be connected to connector unit 170 [act 820]. These peripheral components may include, for example, DVD device 120, VCR 130, video game unit 140, cable/satellite receiver unit 150, computer 160, a surround sound system, camcorder, or the like. Each of these peripheral components may connect to connector unit 170 via a coaxial cable, 3 RCA cable, S video cable, or another similar type of cable. As an example, DVD device 120 may connect to connector unit 170 via an S video cable. To connect DVD device 120, a user may connect an S video cable to the appropriate output of DVD device 120 and connect the other end of the S video cable to S video connector 268 of DVD connector set 240.

Once television 110 and the desired peripheral components are connected to connector unit 170, the user may select a component from which signals are to be routed [act 830]. As described above with respect to FIGS. 2-4, the user may select the desired component using, for example, selector knob 280, selector button 380, remote control 480, or some other technique. Once selected, connector unit 170 may route video and/or audio signals between television 110 and the selected peripheral component [act 840]. As described above, the routing of signals between the devices connected to connector unit 170 may involve formatting the signals for transmission via the appropriate connection cable.

### Exemplary Alternative Implementation

A. Exemplary System

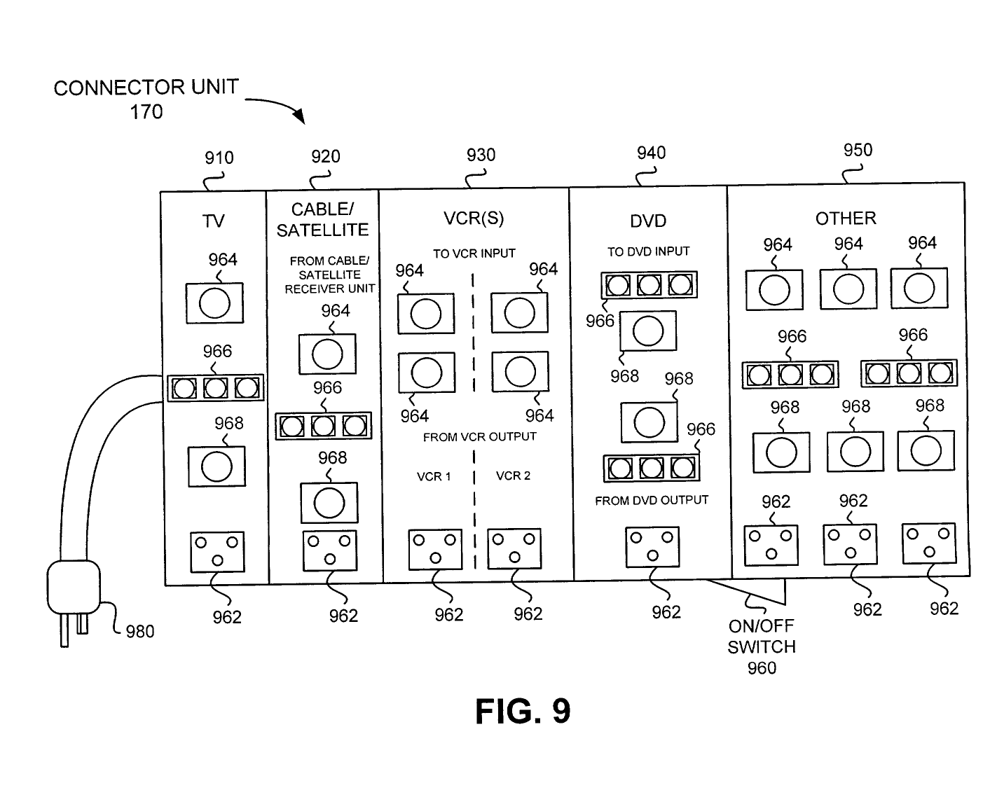

FIG. 9 illustrates an exemplary alternative configuration of the connector unit 170 of FIG. 1 in an implementation consistent with the present invention. As illustrated, connector unit 170 may include a set of television connectors 910, a set of cable/satellite connectors 920, a set of VCR connectors 930, a set of DVD connectors 940, a set of other connectors 950, a power switch 960, and a power cord 980. Power switch 960 includes an “on” and “off” position. When in the “on” position, power switch 960 allows power to be supplied to connector unit 170. When in the “off” position, power switch 960 prohibits power from being supplied to connector 170. Power cord 980 allows connector 170 to be connected to a power supply. Connector unit 170 may also provide surge protection for the components connected thereto.

Television connector set 910 may include one or more connectors for interconnecting television 110 to connector unit 170. The connectors may include, for example, a coaxial cable connector 964, a 3 RCA cable connector 966, and an S video cable connector 968. Coaxial cable connector 964 is capable of receiving a coaxial cable. 3 RCA cable connector 966 is capable of receiving a 3 RCA cable. S video cable connector 968 is capable of receiving an S video cable. Television connector set 910 may also include one or more power receptacles 962 for receiving a power cable from television 110.

Cable/satellite connector set 920 may include one or more connectors for interconnecting cable/satellite receiver unit 150 to connector unit 170. The connectors may include, for example, a coaxial cable connector 964, a 3 RCA cable connector 966, and an S video cable connector 968. Cable/satellite connector set 910 may also include one or more power receptacles 962 for receiving a power cable from cable/satellite receiver unit 150.

VCR connector set 930 may include connectors for interconnecting one or more VCRs 130 to connector unit 170. The connectors may include, for example, coaxial cable connectors 964, 3 RCA cable connectors (not shown), and S video cable connectors (not shown). Coaxial cable connectors 964 may include connectors via which video and audio signals are transmitted to VCR 130 and connectors via which video and audio signals are received from VCR 130. Connector unit 170 may facilitate the connection of the appropriate coaxial cables to the appropriate coaxial cable connectors 964 by indicating on connector unit 170 where the cables are to be connected. For example, connector unit 170 may include labeling, such as “TO VCR INPUT” and “FROM VCR OUTPUT,” to aid a user in interconnecting connector unit 170 and VCR 130. In an alternative implementation, VCR connector set 930 (and the other sections 910, 920, 940, and 950) of connector unit 170 may include color coding to facilitate the connection of cables to the appropriate location on connector unit 170. VCR connector set 930 may also include one or more power receptacles 962 for receiving a power cable from VCR 130.

DVD connector set 940 may include one or more connectors for interconnecting DVD device 120 to connector unit 170. The connectors may include, for example, 3 RCA cable connectors 966 and S video cable connectors 968. When DVD device 120 includes recording capabilities, connector unit 170 may include separate connectors for receiving video and audio signals from DVD device 120 and separate connectors for transmitting video and audio signals to DVD device 120. In such a situation, connector unit 170 may include labeling, such as “TO DVD INPUT” and “FROM DVD OUTPUT,” to aid a user in interconnecting DVD device 120 and connector unit 170. Alternatively, a single connector may transport video and audio signals between DVD device 120 and connector unit 170. DVD connector set 940 may also include one or more power receptacles 962 for receiving a power cable from DVD 120.

Other connector set 950 may include one or more connectors for interconnecting other entertainment components, such as a video game unit 140, a computer 160, a camcorder, a surround sound system, or the like, to connector unit 170. The connectors may include, for example, one or more coaxial cable connectors 964, one or more 3 RCA cable connectors 966, one or more S video cable connectors 968, or other types of connectors. Other connector set 950 may also include one or more power receptacles 962 for receiving a power cable from the components connected to connector unit 170 in other connector set 950.

It will be appreciated that by labeling the different sections of connector unit 170 in the manner illustrated in FIG. 9 facilitates the connection of cables to connector unit 170. For example, a user could readily determine that a coaxial cable from a television, such as television 110, should be connected to the appropriate connector in television connector set 910. Alternatively, color coding may be used to facilitate the connection of cables to connector unit 170. The number and types of connectors in each connector set 910-950 have been provided for simplicity. It will be appreciated that connector unit 170 may include more or fewer connectors or other types of connectors than illustrated in FIG. 9.

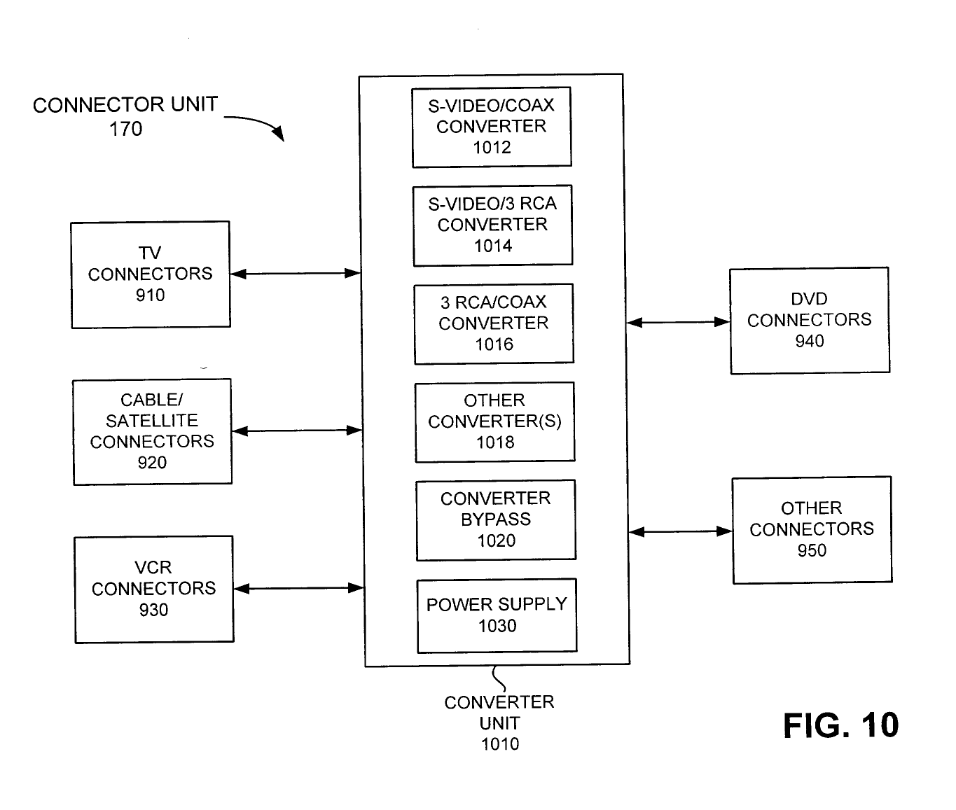

FIG. 10 illustrates an exemplary functional block diagram of connector unit 170 of FIG. 9. As illustrated, connector unit 170 may include television (TV) connector set 910, cable/satellite connector set 920, VCR connector set 930, DVD connector set 940, other connector set 950, and a converter unit 1010. As set forth above, TV connector set 910, cable/satellite connector set 920, VCR connector set 930, DVD connector set 940, and other connector set 950 may include coaxial cable connectors, 3 RCA cable connectors, S video cable connectors, and/or other conventional types of connectors.

Converter unit 1010 may include an S video/coax converter 1012, an S video/3 RCA converter 1014, a 3 RCA/coax converter 1016, other converters 1018, a converter bypass unit 1020, and a power supply 1030. S video/coax converter 1012 formats signals transmitted over an S video cable for transmission over a coaxial cable, and vice versa, using well-known techniques. S video/3 RCA converter 1014 formats signals transmitted over an S video cable for transmission over a 3 RCA cable, and vice versa, using well-known techniques. 3 RCA/coax converter 1016 formats signals transmitted over a 3 RCA cable for transmission over a coaxial cable, and vice versa, using well-known techniques. Other converters 1018 may include one or more converters that format signals for transmission between other types of conventional cables. Converter bypass unit 1020 transports signals between similar connectors. For example, converter bypass unit 1020 may transport signals between a coaxial connector of VCR connectors 930 and a coaxial connector of TV connectors 910.

Power supply 1030 routes power to the components connected to connector unit 170. Power supply 1030 may also provide surge protection for the components connected to connector unit 170 in a well-known manner.

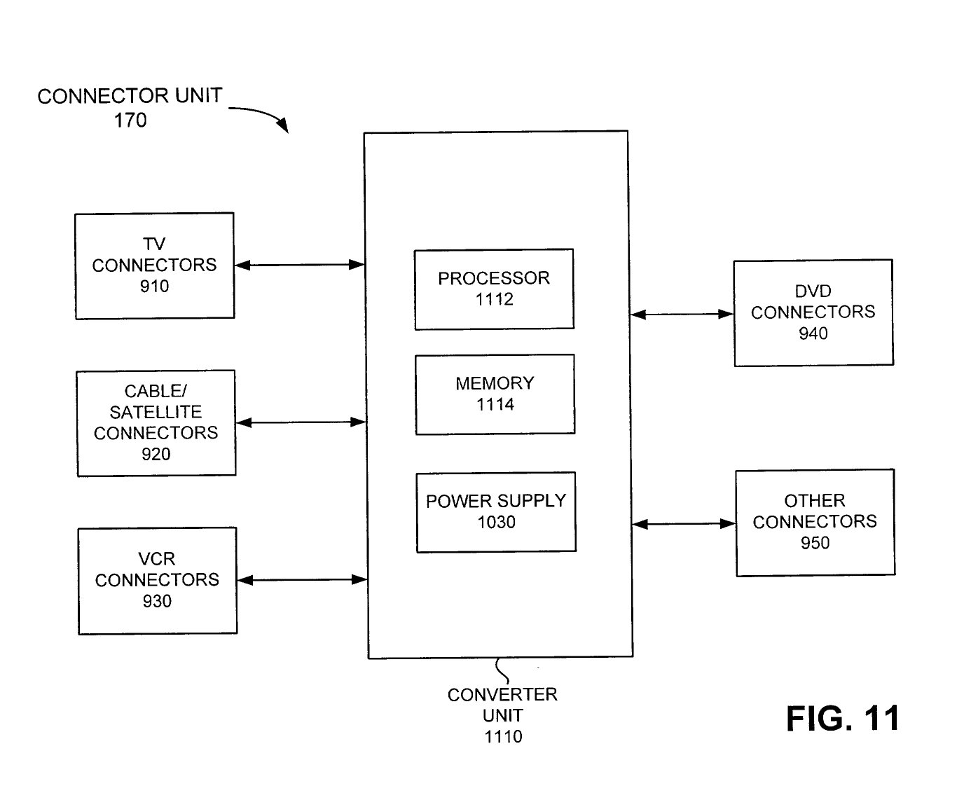

FIG. 11 illustrates an alternative exemplary functional block diagram of connector unit 170 of FIG. 9. As illustrated, connector unit 170 may include TV connectors 910, cable/satellite connectors 920, VCR connectors 930, DVD connectors 940, other connectors 950, and a converter unit 1110. As set forth above, TV connector set 910, cable/satellite connector set 920, VCR connector set 930, DVD connector set 940, and other connector set 950 may include coaxial cable connectors, 3 RCA cable connectors, S video cable connectors, and/or other conventional types of connectors.

In this implementation, converter unit 1110 may include a processor 1112, a memory 1114, and a power supply 1030. Power supply 1030 may be implemented in a manner similar to that described above with respect to FIG. 10. Processor 1112 may include any type of conventional processor or microprocessor that interprets and executes instructions. Memory 1114 may include a random access memory (RAM) or another type of dynamic storage device that stores information and instructions for execution by processor 1112 and/or a read only memory (ROM) or another type of static storage device that stores static information and instructions for use by processor 1112.

Processor 1112 performs the functions described above with respect to converters 1012-1018 and converter bypass unit 1020. That is, processor 1112 receives signals from a connector, formats the signals (if necessary), and forwards the signals to the appropriate destination connector. For example, assume that DVD device 120 transmits signals to television 110. Assume further that DVD device 120 connects to connector unit 170 via an S video cable and that television 110 connects to connector unit 170 via a coaxial cable. In such a situation, processor 1112 may receive signals from an S-video connector 968 of DVD connector set 940, format the signals for transmission via a coaxial cable, and forward the signals to a coaxial connector 964 of television connector set 910.

B. Exemplary Processing

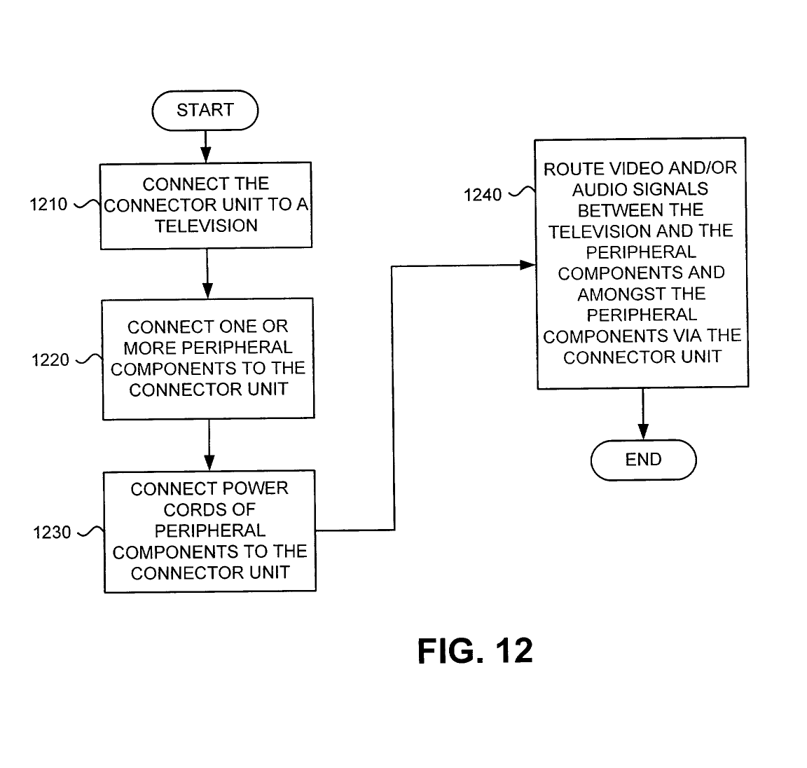

FIG. 12 illustrates an exemplary process for connecting components to a television in an implementation consistent with the present invention. Processing may begin by connecting a television, such as television 110, to connector unit 170 [act 1210]. As described above, television 110 may, for example, connect to an appropriate connector of television connector set 910 of connector unit 170 via a coaxial cable, 3 RCA cable, an S video cable, or some other similar type of cable.

Other peripheral components may be connected to connector unit 170 [act 1220]. These peripheral components may include, for example, DVD device 120, VCR 130, video game unit 140, cable/satellite receiver unit 150, computer 160, a surround sound system, camcorder, or the like. Each of these peripheral components may connect to connector unit 170 via a coaxial cable, 3 RCA cable, S video cable, or another type of cable. As an example, DVD device 120 may connect to connector unit 170 via an S video cable. To connect DVD device 120, a user may connect an S video cable to the appropriate output of DVD device 120 and connect the other end of the S video cable to S video connector 968 of DVD connector set 940.

The power cords of television 110 and the desired peripheral components may be connected to the appropriate power receptacles 962 of connector unit 170 [act 1230]. Once television 110 and the desired peripheral components are connected to connector unit 170, connector unit 170 may route video and/or audio signals between television 110 and the peripheral components and amongst the peripheral components, such as between cable/satellite receiver unit 150 and VCR 130 [act 1240]. As described above, the routing of signals between the devices connected to connector unit 170 may involve formatting the signals for transmission via the appropriate connection cable.

In the event of a power surge, connector unit 170 protects the components connected thereto by, for example, diverting the power surge to a grounding wire in connector unit 170 in a well-known manner. Thus, connector unit 170 facilitates the connection of components in an entertainment system while simultaneously protecting the components from electrical surges.

### CONCLUSION

Systems and methods consistent with the present invention provide a connector unit that facilitates the connection of peripheral components, such as DVD players/recorders, VCRs, video game consoles, cable and/or satellite receivers, computers, surround sound systems, camcorders, and the like, to a television and the routing of signals to the television from these peripheral components. The connector unit separates the connectors for the different peripheral components and provides easy-to-understand labeling (or color coding) to aid users (especially unskilled users) in properly connecting and disconnecting peripheral components. Moreover, in those situations where several peripheral components are connected to the television, connector unit 170 aids in keeping the cables connecting the peripheral devices to the television from getting tangled and improves the overall appearance of the entertainment system.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while the above description focused on interconnecting a television and peripheral components using a single connector unit, the present invention is not so limited. Multiple connector units may be connected together to allow a greater number of entertainment components to be interconnected. Multiple connector units may be connected by, for example, connecting the connector units together using a coaxial cable, 3 RCA cable, S video cable, or some other conventional type of cable.

The above implementations can be implemented in software, hardware, or a combination of software and hardware. Thus, the present invention is not limited to any specific combination of hardware circuitry and software.

While series of acts have been described with regard to FIGS. 8 and 12, the order if the acts may be varied in other implementations consistent with the present invention. Moreover, non-dependent acts may be implemented in parallel. No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. A method for interconnecting a plurality of components in an entertainment system, comprising:
connecting a television to a connector unit;
connecting the plurality of components to the connector unit;
selecting one of the plurality of components; and
routing signals from the selected component to the television via the connector unit.

2. The method of claim 1 wherein the plurality of components include one or more of a digital video disk (DVD) device, a video cassette recorder, a video game console, a cable receiver, a satellite receiver, a computer device, a surround sound system, and a camcorder.

3. The method of claim 1 wherein the routing includes:
formatting signals from a first format to a second different format.

4. The method of claim 1 wherein the connecting a television includes:
connecting the television to the connector unit using one of a coaxial cable, an S video cable, and a 3 RCA cable.

5. The method of claim 4 wherein the connector unit includes a group of dedicated connectors.

6. The method of claim 5 wherein the connecting a television further includes:
connecting the television to a dedicated television connector.

7. The method of claim 1 wherein the connecting the plurality of components to the connector unit includes:
connecting each of the plurality of components using one or more of a coaxial cable, an S video cable, and a 3 RCA cable.

8. The method of claim 1 wherein the selecting includes:
selecting the component via a selector knob.

9. The method of claim 1 wherein the selecting includes:
selecting the component by depressing a button associated with the component.

10. The method of claim 1 wherein the selecting includes:
selecting the component using a remote control.

11. A system for routing signals in an entertainment system, comprising:
one or more television connectors configured to receive one or more connector cables from a television;
one or more cable/satellite receiver connectors configured to receive one or more connector cables from one of a cable receiver and satellite receiver;
one or more video cassette recorder (VCR) connectors configured to receive one or more connector cables from one or more VCRs;
one or more digital video disk (DVD) connectors configured to receive one or more connector cables from a DVD device;
a selector device configured to receive a selection of one of the cable or satellite receiver, the one or more VCRs, and the DVD device from a user; and
a converter unit configured to format signals for transmission between the television and the selected one of the cable or satellite receiver, the one or more VCRs, and the DVD device.

12. The system of claim 11 further comprising:
at least one other connector configured to receive a cable from one or more of a computer, a video game console, a camcorder, and a surround sound system.

13. The system of claim 11 wherein the one or more television connectors, the one or more cable/satellite receiver connectors, the one or more VCR connectors, and the one or more digital video disk (DVD) connectors are separately located on the system.

14. The system of claim 11 wherein the converter unit includes:
a first converter configured to format signals for transmission between an S video cable and a coaxial cable,
a second converter configured to format signals for transmission between an S video cable and a 3 RCA cable, and
a third converter configured to format signals for transmission between a 3 RCA cable and a coaxial cable.

15. The system of claim 14 wherein the converter unit further includes:
a converter bypass unit configured to bypass the formatting of signals.

16. The system of claim 11 wherein the selector device includes a selector knob.

17. The system of claim 11 wherein the selector device includes a plurality of selector buttons, each of the plurality of selector buttons being associated with a different one of the one or more cable/satellite receiver connectors, the one or more VCR connectors, and the one or more digital video disk (DVD) connectors.

18. The system of claim 11 wherein the selector includes a remote control sensing device.

19. A method for connecting components in an entertainment system, comprising:
connecting a cable from a television to a connector unit;
connecting a power cord from the television to the connector unit;
connecting at least one cable from each of a plurality of components to the connector unit;
connecting a power cord from each of the plurality of components to the connector unit; and
routing signals between the plurality of components and the television via the connector unit.

20. The method of claim 19 wherein the connector unit provides surge protection for the television and the plurality of components.
